(19) United States
(12) Patent Application Publication
(10) Pub. No.: US 2025/0175287 A1
(43) Pub. Date: May 29, 2025

(54) METHODS AND APPARATUSES FOR HARQ-ACK FEEDBACK TIMING DETERMINATION FOR CARRIER AGGREGATION

(71) Applicant: Lenovo (Beijing) Limited, Beijing (CN)

(72) Inventor: Haipeng Lei, Beijing (CN)

(73) Assignee: Lenovo (Beijing) Limited, Beijing (CN)

(21) Appl. No.: 18/842,369

(22) PCT Filed: Apr. 29, 2022
(86) PCT No.: PCT/CN2022/090366

§ 371 Date: Aug. 28, 2024

(51) Int. Cl. H04L 1/1829; H04W 72/1268; H04W 72/232

(52) U.S. Cl. CPC H04L 1/1854; H04W 72/1268; H04W 72/232

(57) ABSTRACT

The present application relates to methods and apparatuses for hybrid automatic repeat request-acknowledgement (HARQ-ACK) feedback timing determination for carrier aggregation. One embodiment of the present disclosure provides a user equipment (UE), which includes: a transceiver; and a processor coupled with the transceiver and configured to: receive, with the transceiver, a first plurality of physical downlink shared channel (PDSCH) transmissions on a first plurality of carriers, wherein the first plurality of PDSCH transmissions is scheduled by a downlink control information (DCI) format; determine that the first plurality of carriers are included in a first cell group and a HARQ-ACK feedback for the first plurality of PDSCH transmissions is to be transmitted in a first physical uplink control channel (PUCCH); determine a first slot for transmitting the first PUCCH, wherein the first slot is determined based on at least one of a first reference subcarrier spacing, a first reference slot, or a first HARQ-ACK feedback timing offset between the first reference slot and the first slot; and transmit, with the transceiver, the first PUCCH in the first slot.

### TECHNICAL FIELD

The present disclosure relates to communication technologies, and more particularly, to methods and apparatuses for hybrid automatic repeat request (HARQ) acknowledgement (ACK) feedback timing determination for carrier aggregation (CA).

### BACKGROUND OF THE INVENTION

The 3rd generation partnership project (3GPP) 5G new radio (NR) may support a maximum of 16 component carriers (CCs) in case of carrier aggregation (CA), and may support a maximum of 32 CCs in case of dual connectivity (DC). Scheduling multiple physical downlink shared channel (PDSCH) transmissions or multiple physical uplink shared channel (PUSCH) transmissions on multiple carriers via a single downlink control information (DCI) format may greatly reduce signaling overhead.

However, how to determine the slot for transmitting the physical uplink control channel (PUCCH) carrying the HARQ-ACK feedback for the multiple PDSCH transmissions is an important issue to be resolved, since different carriers may use different subcarrier spacings and may be configured with different time domain resource allocation lists, e.g., k0, SLIV and PDSCH mapping type in each entry of the lists may be different.

Accordingly, it is advantageous to provide solutions for determining timing of the HARQ-ACK feedback for the multiple PDSCH transmissions on multiple carriers.

### SUMMARY

One embodiment of the present disclosure provides a user equipment (UE), which includes: a transceiver; and a processor coupled with the transceiver and configured to: receive, with the transceiver, a first plurality of PDSCH transmissions on a first plurality of carriers, wherein the first plurality of PDSCH transmissions is scheduled by a DCI format; determine that the first plurality of carriers are included in a first cell group and a HARQ-ACK feedback for the first plurality of PDSCH transmissions is to be transmitted in a first PUCCH; determine a first slot for transmitting the first PUCCH, wherein the first slot is determined based on at least one of a first reference subcarrier spacing, a first reference slot, or a first HARQ-ACK feedback timing offset between the first reference slot and the first slot; and transmit, with the transceiver, the first PUCCH in the first slot.

In some embodiments, the processor is further configured to: receive, with the transceiver, a second plurality of PDSCH transmissions on a second plurality of carriers, wherein both the first plurality of PDSCH transmissions and the second plurality of PDSCH transmissions are scheduled by the DCI format; determine that the second plurality of carriers are included in a second cell group and a HARQ-ACK feedback for the second plurality of PDSCH transmissions is to be transmitted in a second PUCCH; determine a second slot for transmitting the second PUCCH, wherein the second slot is determined based on at least one of a second reference subcarrier spacing, a second reference slot, or a second HARQ-ACK feedback timing offset between the second reference slot and the second slot; and transmit, with the transceiver, the second PUCCH in the second slot.

In some embodiments, the first cell group and the second cell group are determined based on at least one of the following: the first cell group and the second cell group are within different frequency ranges; one of the first cell group and the second cell group is on a shared spectrum for access and the other cell group is not on a shared spectrum for access; or the first plurality of carriers is configured within the first cell group and the second plurality of carriers is configured within the second cell group by radio resource control (RRC) signaling.

In some embodiments, the first HARQ-ACK feedback timing offset and the second HARQ-ACK feedback timing offset are indicated by a single HARQ-ACK feedback timing indicator included in the DCI format.

In some embodiments, the first HARQ-ACK feedback timing offset and the second HARQ-ACK feedback timing offset are separately indicated by two HARQ-ACK feedback timing indicators included in the DCI format.

In some embodiments, the first reference subcarrier spacing is determined based on at least one of the following: the first reference subcarrier spacing is configured by an RRC signaling; the first reference subcarrier spacing is a subcarrier spacing associated with a carrier where the first PUCCH is to be transmitted; the first reference subcarrier spacing is a subcarrier spacing associated with a carrier where the DCI format is received; the first reference subcarrier spacing is a largest subcarrier spacing among all subcarrier spacings of the first plurality of carriers; the first reference subcarrier spacing is a smallest subcarrier spacing among all subcarrier spacings of the first plurality of carriers; the first reference subcarrier spacing is a subcarrier spacing associated with a carrier where a last PDSCH transmission of the first plurality of PDSCH transmissions is received; the first reference subcarrier spacing is a subcarrier spacing associated with a carrier where an earliest PDSCH transmission of the first plurality of PDSCH transmissions is received; the first reference subcarrier spacing is a subcarrier spacing associated with a carrier with a smallest serving cell index among all carriers configured for the UE in the first cell group; the first reference subcarrier spacing is a subcarrier spacing associated with a carrier with a smallest serving cell index among all carriers scheduled by the DCI format; the first reference subcarrier spacing is a subcarrier spacing associated with a carrier with a smallest serving cell index among the first plurality of carriers; the first reference subcarrier spacing is a subcarrier spacing associated with a carrier with a largest serving cell index among all carriers configured for the UE in the first cell group; the first reference subcarrier spacing is a subcarrier spacing associated with a carrier with a largest serving cell index among all carriers scheduled by the DCI format; the first reference subcarrier spacing is a subcarrier spacing associated with a carrier with a largest serving cell index among the first plurality of carriers; the first reference subcarrier spacing is a subcarrier spacing associated with a first scheduled carrier among all carriers scheduled by the DCI format; the first reference subcarrier spacing is a subcarrier spacing associated with a first scheduled carrier among the first plurality of carriers; the first reference subcarrier spacing is a subcarrier spacing associated with a last scheduled carrier among all carriers scheduled by the DCI format; the first reference subcarrier spacing is a subcarrier spacing associated with a last scheduled carrier among all the first plurality of carriers; or the first reference subcarrier spacing is a subcarrier spacing associated with the first reference slot.

In some embodiments, the first reference slot is determined based on one of the following: the first reference slot is a slot where a last PDSCH transmission in the first plurality of PDSCH transmissions is received; the first reference slot is a slot where an earliest PDSCH transmission in the first plurality of PDSCH transmissions is received; or the first reference slot is a slot where the DCI format is received.

In some embodiments, HARQ-ACK information bits for the first plurality of PDSCH transmissions are generated per scheduled carrier among the first plurality of carriers and then concatenated based on an order of serving cell indices of the corresponding scheduled carriers.

In some embodiments, a total number of the HARQ-ACK information bits for the first plurality of PDSCH transmissions is configured by RRC signaling.

Another embodiment of the present disclosure provides a base station (BS), which includes: a transceiver; and a processor coupled with the transceiver and configured to: transmit, with the transceiver, a first plurality of PDSCH transmissions on a first plurality of carriers, wherein the first plurality of PDSCH transmissions is scheduled by a DCI format; determine that the first plurality of carriers are included in a first cell group and a HARQ-ACK feedback for the first plurality of PDSCH transmissions is to be received in a first PUCCH; determine a first slot for receiving the first PUCCH, wherein the first slot is determined based on at least one of a first reference subcarrier spacing, a first reference slot, or a first HARQ-ACK feedback timing offset between the first reference slot and the first slot; and receive, with the transceiver, the first PUCCH in the first slot.

In some embodiments, the processor is further configured to: transmit, with the transceiver, a second plurality of PDSCH transmissions on a second plurality of carriers, wherein both the first plurality of PDSCH transmissions and the second plurality of PDSCH transmissions are scheduled by the DCI format; determine that the second plurality of carriers are included in a second cell group and a HARQ-ACK feedback for the second plurality of PDSCH transmissions is to be received in a second PUCCH; determine a second slot for receiving the second PUCCH, wherein the second slot is determined based on at least one of a second reference subcarrier spacing, a second reference slot, or a second HARQ-ACK feedback timing offset between the second reference slot and the second slot; and receive, with the transceiver, the second PUCCH in the second slot.

In some embodiments, the first cell group and the second cell group are determined based on at least one of the following: the first cell group and the second cell group are within different frequency ranges; one of the first cell group and the second cell group is on a shared spectrum for access and the other cell group is not on a shared spectrum for access; or the first plurality of carriers is configured within the first cell group and the second plurality of carriers is configured within the second cell group by radio resource control (RRC) signaling.

In some embodiments, the first HARQ-ACK feedback timing offset and the second HARQ-ACK feedback timing offset are indicated by a single HARQ-ACK feedback timing indicator included in the DCI format.

In some embodiments, the first HARQ-ACK feedback timing offset and the second HARQ-ACK feedback timing offset are separately indicated by two HARQ-ACK feedback timing indicators included in the DCI format.

In some embodiments, the first reference subcarrier spacing is determined based on at least one of the following: the first reference subcarrier spacing is configured by an RRC signaling; the first reference subcarrier spacing is a subcarrier spacing associated with a carrier where the first PUCCH is to be received; the first reference subcarrier spacing is a subcarrier spacing associated with a carrier where the DCI format is transmitted; the first reference subcarrier spacing is a largest subcarrier spacing among all subcarrier spacings of the first plurality of carriers; the first reference subcarrier spacing is a smallest subcarrier spacing among all subcarrier spacings of the first plurality of carriers; the first reference subcarrier spacing is a subcarrier spacing associated with a carrier where a last PDSCH transmission of the first plurality of PDSCH transmissions is transmitted; the first reference subcarrier spacing is a subcarrier spacing associated with a carrier where an earliest PDSCH transmission of the first plurality of PDSCH transmissions is transmitted; the first reference subcarrier spacing is a subcarrier spacing associated with a carrier with a smallest serving cell index among all carriers configured for the UE in the first cell group; the first reference subcarrier spacing is a subcarrier spacing associated with a carrier with a smallest serving cell index among all carriers scheduled by the DCI format; the first reference subcarrier spacing is a subcarrier spacing associated with a carrier with a smallest serving cell index among the first plurality of carriers; the first reference subcarrier spacing is a subcarrier spacing associated with a carrier with a largest serving cell index among all carriers configured for the UE in the first cell group; the first reference subcarrier spacing is a subcarrier spacing associated with a carrier with a largest serving cell index among all carriers scheduled by the DCI format; the first reference subcarrier spacing is a subcarrier spacing associated with a carrier with a largest serving cell index among the first plurality of carriers; the first reference subcarrier spacing is a subcarrier spacing associated with a first scheduled carrier among all carriers scheduled by the DCI format; the first reference subcarrier spacing is a subcarrier spacing associated with a first scheduled carrier among the first plurality of carriers; the first reference subcarrier spacing is a subcarrier spacing associated with a last scheduled carrier among all carriers scheduled by the DCI format; the first reference subcarrier spacing is a subcarrier spacing associated with a last scheduled carrier among all the first plurality of carriers; or the first reference subcarrier spacing is a subcarrier spacing associated with the first reference slot.

In some embodiments, the first reference slot is determined based on one of the following: the first reference slot is a slot where a last PDSCH transmission in the first plurality of PDSCH transmissions is transmitted; the first reference slot is a slot where an earliest PDSCH transmission in the first plurality of PDSCH transmissions is transmitted; or the first reference slot is a slot where the DCI format is transmitted.

In some embodiments, HARQ-ACK information bits for the first plurality of PDSCH transmissions are generated per scheduled carrier among the first plurality of carriers and then concatenated based on an order of serving cell indices of the corresponding scheduled carriers.

In some embodiments, a total number of the HARQ-ACK information bits for the first plurality of PDSCH transmissions is configured by RRC signaling.

Yet another embodiment of the present disclosure provides a method performed by a UE, which includes: receiving a first plurality of PDSCH transmissions on a first plurality of carriers, wherein the first plurality of PDSCH transmissions is scheduled by a DCI format; determining that the first plurality of carriers are included in a first cell group and a HARQ-ACK feedback for the first plurality of PDSCH transmissions is to be transmitted in a first PUCCH; determining a first slot for transmitting the first PUCCH, wherein the first slot is determined based on at least one of a first reference subcarrier spacing, a first reference slot, or a first HARQ-ACK feedback timing offset between the first reference slot and the first slot; and transmitting the first PUCCH in the first slot.

Still another embodiment of the present disclosure provides a method performed by a BS, which includes: transmitting a first plurality of PDSCH transmissions on a first plurality of carriers, wherein the first plurality of PDSCH transmissions is scheduled by a DCI format; determining that the first plurality of carriers are included in a first cell group and a HARQ-ACK feedback for the first plurality of PDSCH transmissions is to be received in a first PUCCH; determining a first slot for receiving the first PUCCH, wherein the first slot is determined based on at least one of a first reference subcarrier spacing, a first reference slot, or a first HARQ-ACK feedback timing offset between the first reference slot and the first slot; and receiving the first PUCCH in the first slot.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of an exemplary wireless communication system according to some embodiments of the present disclosure.

FIGS. 2A and 2B illustrate multiple PDSCH transmissions on multiple carriers scheduled by a single DCI format according to some embodiments of the present disclosure.

FIG. 3 illustrates multiple PDSCH transmissions on multiple carriers scheduled by a single DCI format and a PUCCH carrying a HARQ-ACK feedback for the multiple PDSCH transmissions according to some embodiments of the present disclosure, where both self-scheduling and cross-carrier scheduling are supported.

FIG. 4 illustrates multiple PDSCH transmissions on multiple carriers scheduled by a single DCI format and a PUCCH carrying a HARQ-ACK feedback for the multiple PDSCH transmissions according to some embodiments of the present disclosure, where only cross-carrier scheduling is supported.

FIG. 5 illustrates multiple PDSCH transmissions on multiple carriers (in two cell groups) scheduled by a single DCI format and two PUCCHs each carrying a HARQ-ACK feedback for PDSCH transmissions on carriers in one cell group according to some embodiments of the present disclosure, where both self-scheduling and cross-carrier scheduling are supported.

FIG. 6 illustrates multiple PDSCH transmissions on multiple carriers (in two cell groups) scheduled by a single DCI format and two PUCCHs each carrying a HARQ-ACK feedback for PDSCH transmissions on carriers in one cell group according to some embodiments of the present disclosure, where only cross-carrier scheduling is supported.

FIG. 7 illustrates a flowchart of an exemplary method for HARQ-ACK feedback according to some embodiments of the present disclosure.

FIG. 8 illustrates a flowchart of another exemplary method for HARQ-ACK feedback according to some embodiments of the present disclosure.

FIG. 9 illustrates a simplified block diagram of an exemplary apparatus for HARQ-ACK feedback according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3GPP 5G NR, 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

FIG. 1 illustrates a schematic diagram of an exemplary wireless communication system 100 in accordance with some embodiments of the present disclosure.

As shown in FIG. 1, the wireless communication system 100 may include at least one UE (e.g., UE 101a and UE 101b, collectively referred to as UEs 101) and at least one BS (e.g., BS 102). Although a specific number of UEs 101 and BS 102 are depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 may include wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BS 102. The BS 102 may communicate with the UE(s) 101 via Uu interface. For example, the BS 102 may transmit downlink (DL) communication signals to the UE(s) 101, and may receive uplink (UL) communication signals from the UE(s) 101.

The wireless communication system 100 may be compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high altitude platform network, and/or other communications networks.

In some embodiments of the present disclosure, the wireless communication system 100 is compatible with the 5G NR of the 3GPP protocol. For example, the BS 102 may transmit data using an orthogonal frequency division multiplexing (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums via a Uu interface, whereas in some other embodiments, the BS 102 and UE(s) 101 may communicate over unlicensed spectrums. The present disclosure is not intended to be limited to the implementation of any particular wireless communication system architecture or protocol.

NR supports a wide range of spectrum in different frequency ranges. It is expected that there will be increasing availability of spectrum in the market for 5G Advanced (5G-A) possibly due to re-farming from the bands originally used for previous cellular generation networks. Especially for low frequency bands, for example, FR1, which may be below 7.125 GHz, the available spectrum blocks tend to be more fragmented and scattered with narrower bandwidth. For FR2 bands (which may be above 24.250 GHz) and some FR1 bands, the available spectrum can be wider such that intra-band multi-carrier operation is necessary. To meet different spectrum needs, it is important to ensure that these scattered spectrum bands or wider bandwidth spectrum can be utilized in a more spectral/power efficient and flexible manner, thus providing higher throughput and decent coverage in the network.

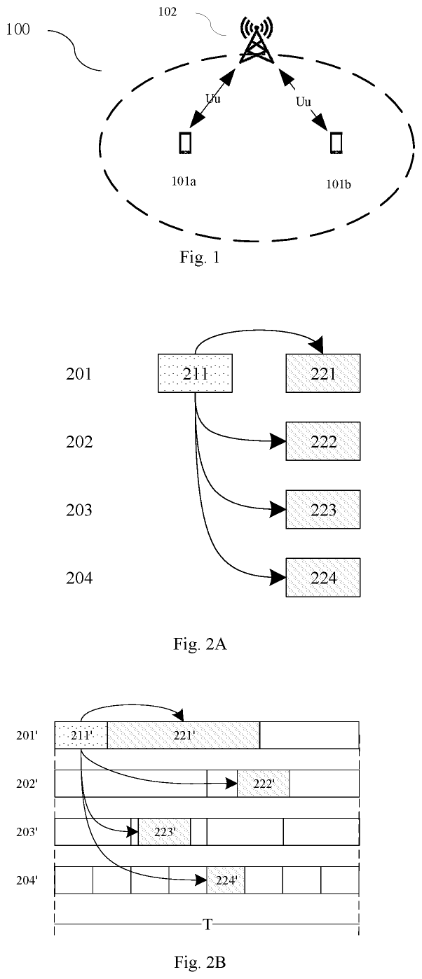

One motivation is to increase flexibility and spectral/power efficiency on scheduling data over multiple cells including intra-band cells and inter-band cells. The current scheduling mechanism only allows scheduling of a single cell PUSCH/PDSCH per a scheduling DCI. With more available scattered spectrum bands or wider bandwidth spectrum, the need of simultaneous scheduling of multiple cells is expected to be increasing. To reduce the control overhead, it is beneficial to extend from single-cell scheduling to multi-cell PUSCH/PDSCH scheduling with a single scheduling DCI. Meanwhile, trade-off between overhead saving and scheduling restriction has to be taken into account. FIGS. 2A and 2B illustrate multiple PDSCH transmissions on multiple carriers scheduled by a single DCI format according to some embodiments of the present disclosure.

In FIG. 2A, a DCI format 211 schedules PDSCH transmissions 221, 222, 223, and 224 on carriers (which may also be referred to as serving cells) 201, 202, 203, and 204, respectively. Each PDSCH transmission is scheduled on one carrier. The DCI format 211 is transmitted on the same carrier (i.e., carrier 201) as the PDSCH transmission 221. The scheduling of the PDSCH transmission 221 by the DCI format 211 may be referred to as self-scheduling. The scheduling of the PDSCH transmissions 222, 223, and 224 by the DCI format 211 may be referred to as cross-carrier scheduling. The carriers 201, 202, 203, and 204 may have the same subcarrier spacing in the example illustrated in FIG. 2A.

In FIG. 2B, a DCI format 211′ schedules PDSCH transmissions 221′, 222′, 223′, and 224′ on carriers 201′, 202′, 203′, and 204′, respectively. Each PDSCH transmission is scheduled on one carrier. The DCI format 211′ is transmitted on the same carrier (i.e., carrier 201′) as the PDSCH transmission 221′. In the example illustrated in FIG. 2B, the carriers 201′, 202′, 203′, and 204′ may have different subcarrier spacings. For example, the subcarrier spacing of carrier 201′ is 15 kHz, the subcarrier spacing of carrier 202′ is 30 kHz, the subcarrier spacing of carrier 203′ is 60 kHz, and the subcarrier spacing of carrier 204′ is 120 kHz. For a time period T, such as 1 ms, one slot is included in the period on carrier 201′, two slots are included in the period on carrier 202′, four slots are included in the period on carrier 203′, and eight slots are included in the period on carrier 204′.

In the case that a single DCI format schedules only one PDSCH transmission, the DCI format may include a HARQ-ACK feedback timing indicator indicating a HARQ-ACK feedback timing value, which is a slot-level offset between a reference slot and the slot where a PUCCH carrying the HARQ-ACK feedback for the PDSCH transmission is to be transmitted. In the case that multiple PDSCH transmissions on multiple carriers are scheduled by a single DCI format, for signaling overhead reduction, it may not be possible to indicate separate HARQ-ACK feedback timing indicators for different carriers, which implies that the scheduled carriers may share the same HARQ-ACK feedback timing value. Then, a reference slot and a reference subcarrier spacing need to be defined for determining the slot where a PUCCH carrying the HARQ-ACK feedback for the multiple PDSCH transmissions is to be transmitted.

Furthermore, when multiple PDSCH transmissions on multiple carriers are scheduled by a single DCI format, the UE may generate and transmit a HARQ-ACK codebook including a combination of HARQ-ACK information bits for the multiple PDSCH transmissions. The BS may determine the combination of HARQ-ACK information bits based on the HARQ-ACK codebook. The UE and the BS should have a common understanding on the HARQ-ACK codebook such that the BS can correctly determine the HARQ-ACK information bits. When the DCI format scheduling multiple PDSCH transmissions is missed by the UE, the UE may not know the existence of the DCI format. Even though the UE can identify that there is a DCI format is missed, the UE may not know how many PDSCH transmissions are scheduled by the missed DCI format. In this sense, the HARQ-ACK codebook for the multiple PDSCH transmissions is mismatched between the UE and the BS, i.e., the HARQ-ACK codebook generated by the UE does not match that the BS expects.

The present disclosure proposes some solutions for addressing at least one of the above issues.

### Solution 1

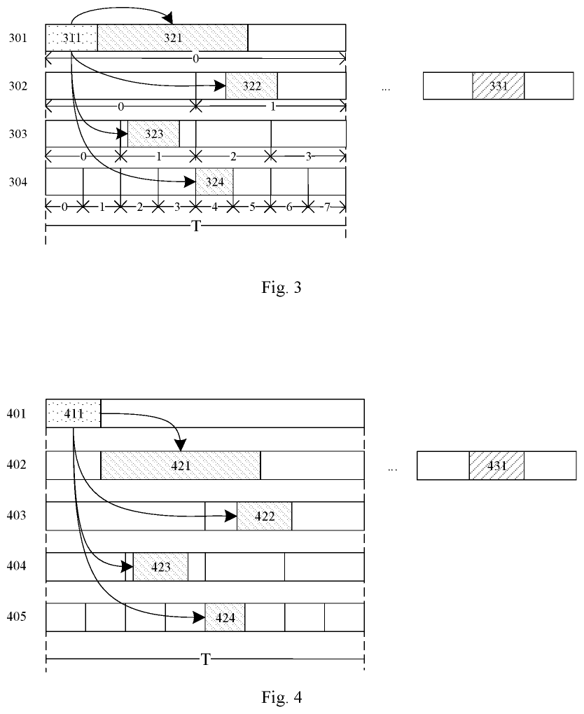

FIG. 3 illustrates multiple PDSCH transmissions on multiple carriers scheduled by a single DCI format and a PUCCH carrying a HARQ-ACK feedback for the multiple PDSCH transmissions according to some embodiments of the present disclosure, where both self-scheduling and cross-carrier scheduling are supported.

Specifically, as shown in FIG. 3, a DCI format 311 schedules PDSCH transmissions 321, 322, 323, and 324 on carriers 301, 302, 303, and 304, respectively. The DCI format 311 is transmitted on carrier 301. The serving cell indices associated with carriers 301, 302, 303, and 304 may be 1, 2, 3, and 4, respectively. The four carriers have different subcarrier spacings. For example, the subcarrier spacing of carrier 301 is 15 kHz, the subcarrier spacing of carrier 302 is 30 kHz, the subcarrier spacing of carrier 303 is 60 kHz, and the subcarrier spacing of carrier 304 is 120 kHz. For a time period T, such as 1 ms, one slot is included in the period on carrier 301, which is indexed as “0”; two slots are included in the period on carrier 302, which are indexed as “0” and “1” respectively; four slots are included in the period on carrier 303, which are indexed as “0”, “1”, . . . , “3” respectively; and eight slots are included in the period on carrier 304, which are indexed as “0”, “1”, . . . , “7” respectively.

In the example illustrated in FIG. 3, all the four carriers may be in the same cell group, and there is only one scheduled PDSCH transmission on each carrier of the scheduled carriers. After receiving the four PDSCH transmissions from a BS, a UE may transmit HARQ-ACK feedback in the form of a HARQ-ACK codebook comprising HARQ-ACK information bits for all the four PDSCH transmissions in a PUCCH 331 in a slot. Hereinafter in the present disclosure, the slot where the PUCCH is transmitted may be referred to as a PUCCH slot for clarity. The PUCCH 331 is transmitted on carrier 302, which may be a primary cell (PCell) or a primary secondary cell (PSCell) in this cell group.

The DCI format 311 may include an indicator indicating a HARQ-ACK feedback timing offset between a reference slot and the PUCCH slot. The indicator may be named as: HARQ-ACK feedback timing indicator, PDSCH-to-HARQ_feedback timing indicator, K1 indicator, or the like. In some embodiments, the indicator may indicate a value from a configured set of HARQ-ACK feedback timing values. For example, the configured set of HARQ-ACK feedback timing values may be {1, 2, 3, 4, 5, 6, 7, 8}, assuming the reference slot is slot n, so the indicator being “0” may indicate the first value within the configured set of HARQ-ACK feedback timing values, i.e., the value “1,” which means the HARQ-ACK feedback is to be transmitted in slot n+1; the indicator being “1” may indicate the second value within the configured set of HARQ-ACK feedback timing values, i.e., the value “2,” which means the HARQ-ACK feedback timing is to be transmitted in slot n+2, and so on. In an embodiment, the configured set of HARQ-ACK feedback timing values may include one or more reserved or inapplicable values, such as zero or a negative number, e.g., −1.

As stated above, the scheduled carriers may have different subcarrier spacings. Thus, for the same absolute time point, slot indices on different carriers are different according to associated subcarrier spacings. Accordingly, a reference subcarrier spacing is defined for determining an offset (e.g., a number of slots) between the reference slot and the PUCCH slot.

The PUCCH slot is determined based on at least one of the following:
a reference subcarrier spacing (represented as “S1”);
a reference slot (represented as “n,” which is the slot index on an associated carrier, where the subcarrier spacing on the associated carrier is represented as “S2”); or
a HARQ-ACK feedback timing offset (represented as “k”).

In some embodiments, the PUCCH slot may be calculated based on the following formula (1):

$$⌊ n \cdot \frac{S 1}{S 2} ⌋ + k 1 \qquad ( 1 )$$

As described above, the HARQ-ACK feedback timing offset, k, may be indicated by an indicator included in the DCI format 311.

The reference subcarrier spacing, S1, may be determined based on at least one of the following options:
Option A1: the reference subcarrier spacing may be configured by an RRC signaling.
Option A2: the reference subcarrier spacing may be the subcarrier spacing associated with the carrier where the PUCCH 331 is to be transmitted by the UE (or received by the BS). For example, in FIG. 3, the PUCCH 331 is to be transmitted on carrier 302, and the reference subcarrier spacing is the subcarrier spacing associated with the carrier 302, which is 30 kHz.
Option A3: the reference subcarrier spacing may be the subcarrier spacing associated with the carrier where the DCI format 311 is transmitted by the BS (or received by the UE). For example, in FIG. 3, the DCI format 311 is transmitted on carrier 301, and the reference subcarrier spacing is the subcarrier spacing associated with the carrier 301, which is 15 kHz.
Option A4: the reference subcarrier spacing may be the largest subcarrier spacing among all subcarrier spacings of the scheduled carriers. For example, in FIG. 3, the subcarrier spacings of the four scheduled carriers are 15 kHz, 30 kHz, 60 kHz, and 120 kHz, respectively, and the largest subcarrier spacing is 120 kHz; therefore, the reference subcarrier spacing is 120 kHz.
Option A5: the reference subcarrier spacing may be the smallest subcarrier spacing among all subcarrier spacings of the scheduled carriers. For example, in FIG. 3, the subcarrier spacings of the four scheduled carriers are 15 kHz, 30 kHz, 60 kHz, and 120 kHz, respectively, and the smallest subcarrier spacing is 15 kHz; therefore, the reference subcarrier spacing is 15 kHz.
Option A6: the reference subcarrier spacing may be a subcarrier spacing associated with a carrier where the last PDSCH transmission among the scheduled PDSCH transmissions is received by the UE (or transmitted by the BS). In an embodiment, the last PDSCH transmission may refer to a PDSCH transmission that ends later than any other PDSCH transmissions in the time domain. For example, in FIG. 3, the last PDSCH transmission is the PDSCH transmission 322 on carrier 302, and the reference subcarrier spacing is the subcarrier spacing associated with carrier 302, which is 30 kHz.
Option A7: the reference subcarrier spacing may be a subcarrier spacing associated with a carrier where the earliest PDSCH transmission among the scheduled PDSCH transmissions is received by the UE (or transmitted by the BS). In an embodiment, the earliest PDSCH transmission may refer to a PDSCH transmission that starts earlier than any other PDSCH transmissions in the time domain. For example, in FIG. 3, the earliest PDSCH transmission is the PDSCH transmission 321 on carrier 301, and the reference subcarrier spacing is the subcarrier spacing associated with carrier 301, which is 15 kHz.
Option A8: the reference subcarrier spacing may be a subcarrier spacing associated with a carrier with a smallest serving cell index among all carriers configured for the UE. For example, in FIG. 3, assuming that the serving cell index of carrier 301 (i.e., 1) is the smallest serving cell index among all carriers configured for the UE, the reference subcarrier spacing is the subcarrier spacing associated with carrier 301, i.e., 15 kHz.
Option A9: the reference subcarrier spacing may be a subcarrier spacing associated with a carrier with a largest serving cell index among all carriers configured for the UE. For example, in FIG. 3, assuming that the serving cell index of carrier 304 (i.e., 4) is the largest serving cell index among all carriers configured for the UE, the reference subcarrier spacing is the subcarrier spacing associated with carrier 304, i.e. 120 kHz.
Option A10: the reference subcarrier spacing may be a subcarrier spacing associated with a carrier with a smallest serving cell index among all carriers scheduled by the DCI format 311. For example, in FIG. 3, among the four carriers scheduled by the DCI format 311, carrier 301 has the smallest serving cell index (i.e., 1), and the reference subcarrier spacing is the subcarrier spacing associated with carrier 301, i.e., 15 kHz.
Option A11: the reference subcarrier spacing may be a subcarrier spacing associated with a carrier with a largest serving cell index among all carriers scheduled by the DCI format 311. For example, in FIG. 3, among the four carriers scheduled by the DCI format 311, carrier 304 has the largest serving cell index (i.e., 4), and the reference subcarrier spacing is the subcarrier spacing associated with carrier 304, i.e., 120 kHz.
Option A12: the reference subcarrier spacing may be a subcarrier spacing associated with a first scheduled carrier among all carriers scheduled by the DCI format 311. For example, in FIG. 3, assuming that, among the four carriers, the first scheduled carrier is carrier 301, the reference subcarrier spacing is the subcarrier spacing associated with carrier 301, i.e., 15 kHz.
Option A13: the reference subcarrier spacing may be a subcarrier spacing associated with a last scheduled carrier among all carriers scheduled by the DCI format 311. For example, in FIG. 3, assuming that, among the four carriers, the last scheduled carrier is carrier 304, the reference subcarrier spacing is the subcarrier spacing associated with carrier 304, i.e., 120 kHz.
Option A14: the reference subcarrier spacing may be a subcarrier spacing associated with the reference slot. For example, in FIG. 3, assuming that, among the four carriers, the reference slot is slot 1 on carrier 302, the reference subcarrier spacing is the subcarrier spacing associated with carrier 302, i.e., 30 kHz.

The reference slot, n, may be determined based on one of the following options:
Option B1: the reference slot may be the slot where the last PDSCH transmission among the PDSCH transmissions on all the scheduled carriers is transmitted by the BS (or received by the UE). For example, in FIG. 3, the last PDSCH transmission is the PDSCH transmission 322 in slot 1 on carrier 302, and the reference slot is slot 1 on carrier 302.
Option B2: the reference slot may be the slot where the earliest PDSCH transmission among the PDSCH transmissions on all the scheduled carriers is transmitted by the BS (or received by the UE). For example, in FIG. 3, the earliest PDSCH transmission is the PDSCH transmission 321 in slot 0 on carrier 301, and the reference slot is slot 0 on carrier 301.
Option B3: the reference slot may be the slot where the PDCCH transmission carrying the DCI format 311 is transmitted by the BS (or received by the UE). For example, in FIG. 3, the PDCCH transmission carrying the DCI format 311 is in slot 0 on carrier 301, and the reference slot is slot 0 on carrier 301.

According to some embodiments of the present disclosure, the UE may first generate a HARQ-ACK information bit for each PDSCH transmission (also for each scheduled carrier), and then concatenate these HARQ-ACK information bits based on an order (e.g., in ascending order) of serving cell indices of the corresponding scheduled carriers to form the HARQ-ACK codebook.

For example, supposing that the UE generates a HARQ-ACK information bit for PDSCH transmission 321 as “1” (or ACK), a HARQ-ACK information bit for PDSCH transmission 322 as “0” (or non-acknowledgement (NACK)), a HARQ-ACK information bit for PDSCH transmission 323 as “1” (or ACK), and a HARQ-ACK information bit for PDSCH transmission 324 as “0” (or NACK). The UE then concatenate these HARQ-ACK information bits in ascending order of serving cell indices of the scheduled carriers, and the generated HARQ-ACK codebook for the four PDSCH transmissions is “1010.”

The total number of HARQ-ACK information bits in the HARQ-ACK codebook for the PDSCH transmissions scheduled by a single DCI format may be equal to a value configured by RRC signaling. In one embodiment, the value is the maximum number of carriers which can be scheduled by the DCI format 311. For example, supposing that the DCI format 311 may schedule up to 4 carriers, the total number of HARQ-ACK information bits in the HARQ-ACK codebook may be equal to 4. In another embodiment, the value is determined based on tradeoff between HARQ-ACK feedback overhead and the probability of missing the DCI format 311, so that the value can be smaller than the maximum number of carriers which can be scheduled by the DCI format 311. For example, supposing that the DCI format 311 may schedule up to 4 carriers, the total number of HARQ-ACK information bits in the HARQ-ACK codebook may be 1, 2, or 3.

In the case that the number of HARQ-ACK information bits generated for all the scheduled PDSCH transmissions is smaller than the configured value, the UE may perform HARQ-ACK padding to the HARQ-ACK information bits, e.g., appending one or more NACK bits in the HARQ-ACK codebook, to align the configured value. In the case that the number of HARQ-ACK information bits generated for all the scheduled PDSCH transmissions is larger than the configured value, the UE may perform HARQ-ACK bundling, e.g., performing logic AND operation among the HARQ-ACK information bits, to align the configured value.

At BS side, the BS may determine a reference subcarrier spacing, a reference slot, and a HARQ-ACK feedback timing offset for the UE to determine a PUCCH slot, and transmit the DCI format 311 including an indicator indicating the HARQ-ACK feedback timing offset to the UE. The DCI format 311 schedules the PDSCH transmissions 321, 322, 323, and 324. The BS may determine the PUCCH slot for receiving a HARQ-ACK codebook for the PDSCH transmissions 321, 322, 323, and 324 based on at least one of the reference subcarrier spacing, the reference slot, and the HARQ-ACK feedback timing offset (e.g., based on formula (1)), and receive the HARQ-ACK codebook in the determined PUCCH slot.

At UE side, after decoding the DCI format 311 from the BS which schedules the PDSCH transmissions 321, 322, 323, and 324, the UE may determine the reference subcarrier spacing (e.g., based on any of Options A1-A14) and the reference slot (e.g., based on any of Options B1-B3), and further determine the PUCCH slot for transmitting the HARQ-ACK codebook for the PDSCH transmissions 321, 322, 323, and 324 based on at least one of the reference subcarrier spacing, the reference slot, and the HARQ-ACK feedback timing offset as indicated by the DCI format 311 (e.g., based on formula (1)). After receiving the PDSCH transmissions 321, 322, 323, and 324, the UE may generate the HARQ-ACK codebook and transmit it in the determined PUCCH slot.

FIG. 4 illustrates multiple PDSCH transmissions on multiple carriers scheduled by a single DCI format and a PUCCH carrying a HARQ-ACK feedback for the multiple PDSCH transmissions according to some embodiments of the present disclosure, where only cross-carrier scheduling is supported.

As shown in FIG. 4, a DCI format 411 is transmitted in a PDCCH on carrier 401, and schedules PDSCH transmissions 421, 422, 423, and 424 on carriers 402, 403, 404, and 405 respectively. The serving cell indices associated with carriers 401, 402, 403, 404, and 405 may be 1, 2, 3, 4, and 5 respectively. The five carriers have different subcarrier spacings. For example, the subcarrier spacing of carrier 401 is 15 kHz, the subcarrier spacing of carrier 402 is 15 kHz, the subcarrier spacing of carrier 403 is 30 kHz, the subcarrier spacing of carrier 404 is 60 kHz, and the subcarrier spacing of carrier 405 is 120 kHz. All the five carriers may be in the same cell group, and there is only one scheduled PDSCH transmission on each carrier of the scheduled carriers. The UE may determine a slot for transmitting the PUCCH 431 carrying a HARQ-ACK feedback for the PDSCH transmissions 421, 422, 423, and 424 according to the method described above with respect to FIG. 3, and transmit the HARQ-ACK feedback in the determined slot.

### Solution 2

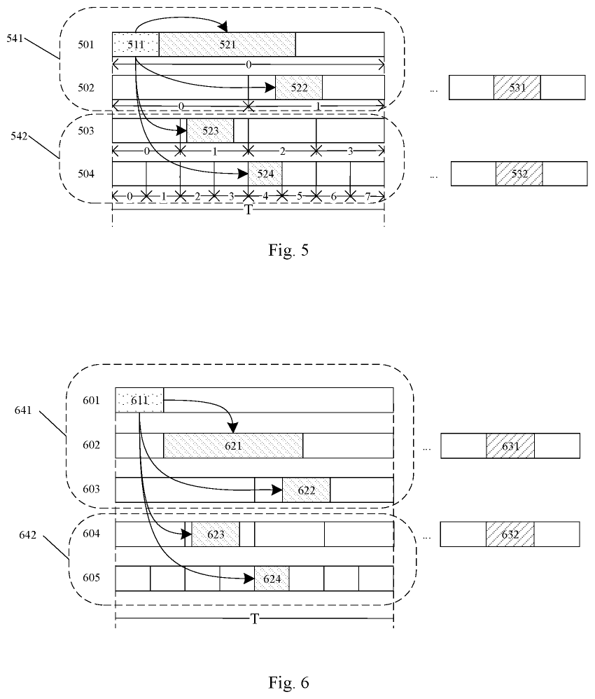

FIG. 5 illustrates multiple PDSCH transmissions on multiple carriers (in two cell groups) scheduled by a single DCI format and two PUCCHs each carrying a HARQ-ACK feedback for PDSCH transmissions on carriers in one cell group according to some embodiments of the present disclosure, where both self-scheduling and cross-carrier scheduling are supported.

As shown in FIG. 5, a DCI format 511 is transmitted in a PDCCH on carrier 501 and schedules PDSCH transmissions 521, 522, 523, and 524 on carriers 501, 502, 503, and 504, respectively. The serving cell indices associated with carriers 501, 502, 503, and 504 may be 1, 2, 3, and 4 respectively. The four carriers have different subcarrier spacings. For example, the subcarrier spacing of carrier 501 is 15 kHz, the subcarrier spacing of carrier 502 is 30 kHz, the subcarrier spacing of carrier 503 is 60 kHz, and the subcarrier spacing of carrier 504 is 120 kHz. For a time period T, such as 1 ms, one slot is included in the period on carrier 501, which is indexed as “0”; two slots are included in the period on carrier 502, which are indexed as “0” and “1” respectively; four slots are included in the period on carrier 503, which are indexed as “0”, “1”, . . . , “3” respectively; and eight slots are included in the period on carrier 504, which are indexed as “0”, “1”, . . . , “7” respectively.

In the example illustrated in FIG. 5, the scheduled carriers may be included in different cell groups. For example, carrier 501 and carrier 502 are included in cell group 541, and carrier 503 and carrier 504 are included in cell group 542.

There are several options for determining the number of cell groups and the number of carriers within each cell group:
Option C1: the number of cell groups may be determined based on whether all the scheduled carriers are within the same frequency range or within different frequency ranges, such as FR1 or FR2.
In the case that all the scheduled carriers are within the same frequency range, for example, within FR1, there is only one cell group and all the scheduled carriers are included in the cell group. In the case that some of the scheduled carriers are within a first frequency range while other scheduled carriers are within a second frequency range, there are two cell groups. For example, the first cell group includes all the carriers scheduled within the first frequency range, e.g., FR1, while the second cell group includes all the carriers scheduled within the second frequency range, e.g., FR2.
Option C2: the number of cell groups may be determined based on whether at least one of the scheduled carriers is on a shared spectrum for access (i.e., an unlicensed spectrum), while others of the scheduled carriers are over a licensed spectrum.
In the case that all the scheduled carriers are either licensed or unlicensed, there is only one cell group and all the scheduled carriers are included in the cell group. In the case that some scheduled carriers are on a licensed spectrum while other scheduled carriers are on an unlicensed spectrum, there are two cell groups. For example, the first cell group includes all the licensed carriers scheduled by the DCI format 511, and the second cell group includes all the unlicensed carriers scheduled by the DCI format 511.
Option C3: the number of cell groups may be configured by RRC signaling. In the case of more than one cell group, for a carrier, the RRC signaling may configure the corresponding cell group, e.g., by configuring the cell group index for the carrier. For example, the RRC signaling may configure a first cell group index for some of the scheduled carriers and a second cell group index for other scheduled carriers, that is, two cell groups are configured.

For each cell group, the UE may determine a HARQ-ACK codebook comprising HARQ-ACK information bits for all the scheduled carriers within the respective cell group, and may transmit the HARQ-ACK codebook in a respective PUCCH in a respective slot.

In the example of FIG. 5, the UE may transmit a first HARQ-ACK codebook comprising HARQ-ACK information bits for PDSCH transmissions 521 and 522 within the cell group 541 in a PUCCH 531 in a first PUCCH slot, and transmit a second HARQ-ACK codebook comprising HARQ-ACK information bits for PDSCH transmissions 523 and 524 within the cell group 542 in a PUCCH 532 in a second PUCCH slot. The PUCCH 531 is transmitted on carrier 502, which may be a PCell or PSCell in the cell group 541. The PUCCH 532 is transmitted on carrier 504, which may be a PCell or PSCell in the cell group 542.

For determining the PUCCH slots for transmitting HARQ-ACK feedbacks, two embodiments are presented as follows:

### Embodiment 1

The DCI format 511 may include a single indicator indicating a HARQ-ACK feedback timing offset between a reference slot and a PUCCH slot. The indicator may be named as: HARQ-ACK feedback timing indicator, PDSCH-to-HARQ_feedback timing indicator, K1 indicator, or the like. In the case that there is only one cell group, the indicator is applied to the cell group; in the case that there are two cell groups, the indicator is applied to both cell groups.

### Embodiment 2

The DCI format 511 may include two separate indicators each indicating a HARQ-ACK feedback timing offset between a reference slot and a PUCCH slot, which may be referred to as a first indicator and a second indicator respectively. The first indicator may indicate a first HARQ-ACK feedback timing offset to be applied to a first cell group, and the second indicator may indicate a second HARQ-ACK feedback timing offset to be applied to a second cell group.

In the case that there is only one cell group, one of the first indicator and the second indicator may indicate an applicable value from a configured set of HARQ-ACK feedback timing values, while the other indicator may indicate an inapplicable value or a reserved value (e.g., zero or a negative number, e.g., −1) from the configured set of HARQ-ACK feedback timing values. For example, assuming that the configured set of HARQ-ACK feedback timing values is {−1, 2, 3, 4} and the reference slot is slot n, the first indicator may be “1,” which indicates the second value within the configured set of HARQ-ACK feedback timing values, i.e., the value “2,” and means the HARQ-ACK feedback is to be transmitted in slot n+2 for the first cell group; and the second indicator may be “0,” which indicates the first value within the configured set of HARQ-ACK feedback timing values, i.e., the value “−1”, and means that there is no second cell group and the second indicator should be neglected, or the HARQ-ACK feedback for the carriers within the second cell group is not needed and disabled.

In the case that there are two cell groups, both the first indicator and the second indicator may indicate applicable values from the configured set of HARQ-ACK feedback timing values. The value indicated by the first indicator may be applied to the first cell group, and the value indicated by the second indicator may be applied to the second cell group.

Regardless of whether embodiment 1 or embodiment 2 is implemented, for each cell group, the UE may determine a PUCCH slot for transmitting a HARQ-ACK codebook for PDSCH transmissions on carriers in the respective cell group. The present disclosure describes below solutions for determining the first PUCCH slot for the first cell group (e.g., cell group 541), and similar solutions may be applied to determine the second PUCCH slot for the second cell group (e.g., cell group 542).

The first PUCCH slot is determined based on at least one of the following:
a first reference subcarrier spacing (represented as “S1₁”) for the first cell group;
a first reference slot (represented as “n₁,” which is the slot index on an associated carrier, where the subcarrier spacing on the associated carrier is represented as “S2₁”) for the first cell group; or
a first HARQ-ACK feedback timing offset (represented as “k1₁”) for the first cell group.

In some embodiments, the first PUCCH slot may be calculated based on the following formula (2):

$$⌊ {n}_{1} \cdot \frac{S {1}_{1}}{S {2}_{1}} ⌋ + k {1}_{1} \qquad ( 2 )$$

As described above, the first HARQ-ACK feedback timing offset, k1₁, may be indicated by an indicator included in the DCI format 511.

The first reference subcarrier spacing, S₁₁, may be determined based on at least one of the following options:
Option D1: the first reference subcarrier spacing may be configured by an RRC signaling for the first cell group.
Option D2: the first reference subcarrier spacing may be the subcarrier spacing associated with the carrier where the PUCCH 531 is to transmitted by the UE (or received by the BS) for the first cell group. For example, in FIG. 5, the PUCCH 531 is to be transmitted on carrier 502, and the first reference subcarrier spacing is the subcarrier spacing associated with the carrier 502, which is 30 kHz.
Option D3: the first reference subcarrier spacing may be the subcarrier spacing associated with the carrier where the DCI format 531 is transmitted by the BS (or received by the UE). For example, in FIG. 5, the DCI format 531 is transmitted on carrier 501, and the first reference subcarrier spacing is the subcarrier spacing associated with the carrier 501, which is 15 kHz. In some embodiments, this option may not apply to the second cell group, because the DCI format 531 is not transmitted on a carrier in the second cell group. In some other embodiments, this option may not apply to the first cell group when the DCI format is not transmitted on a carrier in the first cell group.
Option D4: the first reference subcarrier spacing may be the largest subcarrier spacing among all subcarrier spacings of the scheduled carriers in the first cell group. For example, in FIG. 5, the subcarrier spacings of the two carriers (carriers 501 and 502) in the first cell group are 15 kHz and 30 kHz, respectively, and the largest subcarrier spacing is 30 kHz; therefore, the first reference subcarrier spacing is 30 kHz.
Option D5: the first reference subcarrier spacing may be the smallest subcarrier spacing among all subcarrier spacings of the scheduled carriers in the first cell group. For example, in FIG. 5, the subcarrier spacings of the two carriers in the first cell group are 15 kHz and 30 kHz, respectively, and the smallest subcarrier spacing is 15 kHz; therefore, the first reference subcarrier spacing is 15 kHz.
Option D6: the first reference subcarrier spacing may be a subcarrier spacing associated with a carrier where the last PDSCH transmission among the PDSCH transmissions scheduled on carriers in the first cell group is received by the UE (or transmitted by the BS). For example, in FIG. 5, for the first cell group, the last PDSCH transmission is the PDSCH transmission 522 on carrier 502, and the first reference subcarrier spacing is the subcarrier spacing associated with carrier 502, which is 30 kHz.
Option D7: the first reference subcarrier spacing may be a subcarrier spacing associated with a carrier where the earliest PDSCH transmission among the PDSCH transmissions scheduled on carriers in the first cell group is received by the UE (or transmitted by the BS). For example, in FIG. 5, for the first cell group, the earliest PDSCH transmission is the PDSCH transmission 521 on carrier 501, and the first reference subcarrier spacing is the subcarrier spacing associated with carrier 501, which is 15 kHz.
Option D8: the first reference subcarrier spacing may be a subcarrier spacing associated with a carrier with a smallest serving cell index among all carriers configured for the UE in the first cell group. For example, in FIG. 5, carrier 501 has the smallest serving cell index (i.e., 1) among all carriers configured for the UE in the first cell group, and the first reference subcarrier spacing is the subcarrier spacing associated with carrier 501, i.e., 15 kHz.
Option D9: the first reference subcarrier spacing may be a subcarrier spacing associated with a carrier with a largest serving cell index among all carriers configured for the UE in the first cell group. For example, in FIG. 5, carrier 502 has the largest serving cell index (i.e., 2) among all carriers configured for the UE in the first cell group, and the first reference subcarrier spacing is the subcarrier spacing associated with carrier 502, i.e., 30 kHz.
Option D10: the first reference subcarrier spacing may be a subcarrier spacing associated with a carrier with a smallest serving cell index among all carriers scheduled by the DCI format 511 in the first cell group. For example, in FIG. 5, carriers 501 and 502 in the first cell group are scheduled by the DCI format 511, where carrier 501 has the smallest serving cell index (i.e., 1) among them, and the first reference subcarrier spacing is the subcarrier spacing associated with carrier 501, i.e., 15 kHz.
Option D11: the first reference subcarrier spacing may be a subcarrier spacing associated with a carrier with a largest serving cell index among all carriers scheduled by the DCI format 511 in the first cell group. For example, in FIG. 5, carriers 501 and 502 in the first cell group are scheduled by the DCI format 511, where carrier 502 has the largest serving cell index (i.e., 2) among them, and the first reference subcarrier spacing is the subcarrier spacing associated with carrier 502, i.e., 30 kHz.
Option D12: the first reference subcarrier spacing may be a subcarrier spacing associated with a carrier with a smallest serving cell index among all carriers scheduled by the DCI format 511. For example, in FIG. 5, carriers 501-504 are scheduled by the DCI format 511, where carrier 501 has the smallest serving cell index (i.e., 1) among them, and the first reference subcarrier spacing is the subcarrier spacing associated with carrier 501, i.e., 15 kHz.
Option D13: the first reference subcarrier spacing may be a subcarrier spacing associated with a carrier with a largest serving cell index among all carriers scheduled by the DCI format 511. For example, in FIG. 5, carriers 501-504 are scheduled by the DCI format 511, where carrier 504 has the largest serving cell index (i.e., 4) among them, and the first reference subcarrier spacing is the subcarrier spacing associated with carrier 504, i.e., 120 kHz.
Option D14: the first reference subcarrier spacing may be a subcarrier spacing associated with a first scheduled carrier among all carriers scheduled by the DCI format 511 in the first cell group. For example, in FIG. 5, assuming that, among carriers 501 and 502 in the first cell group, the first scheduled carrier is carrier 501, the first reference subcarrier spacing is the subcarrier spacing associated with carrier 501, i.e., 15 kHz.
Option D15: the first reference subcarrier spacing may be a subcarrier spacing associated with a last scheduled carrier among all carriers scheduled by the DCI format 511 in the first cell group. For example, in FIG. 5, assuming that, among carriers 501 and 502 in the first cell group, the last scheduled carrier is carrier 502, the first reference subcarrier spacing is the subcarrier spacing associated with carrier 502, i.e., 30 kHz.
Option D16: the first reference subcarrier spacing may be a subcarrier spacing associated with a first scheduled carrier among all carriers scheduled by the DCI format 511. For example, in FIG. 5, assuming that, among carriers 501-504 scheduled by the DCI, the first scheduled carrier is carrier 501, the first reference subcarrier spacing is the subcarrier spacing associated with carrier 501, i.e., 15 kHz.
Option D17: the first reference subcarrier spacing may be a subcarrier spacing associated with a last scheduled carrier among all carriers scheduled by the DCI format 511. For example, in FIG. 5, assuming that, among carriers 501-504 scheduled by the DCI format 511, the last scheduled carrier is carrier 503, the first reference subcarrier spacing is the subcarrier spacing associated with carrier 503, i.e., 60 kHz.
Option D18: the first reference subcarrier spacing may be a subcarrier spacing associated with the first reference slot. For example, in FIG. 5, assuming that, for the first cell group, the reference slot is slot 1 on carrier 502, the reference subcarrier spacing for the first cell group is the subcarrier spacing associated with carrier 502, i.e., 30 kHz.

The first reference slot, n₁, may be determined based on one of the following options:
Option E1: the first reference slot may be the slot where the last PDSCH transmission among the PDSCH transmissions on all the scheduled carriers in the first cell group is transmitted by the BS (or received by the UE). For example, in FIG. 5, for the first cell group, the last PDSCH transmission is the PDSCH transmission 522 in slot 1 on carrier 502, and the first reference slot is slot 1 on carrier 502.
Option E2: the first reference slot may be the slot where the earliest PDSCH transmission among the PDSCH transmissions on all the scheduled carriers in the first cell group is transmitted by the BS (or received by the UE). For example, in FIG. 3, for the first cell group, the earliest PDSCH transmission is the PDSCH transmission 521 in slot 0 on carrier 501, and the first reference slot is slot 0 on carrier 501.
Option E3: the first reference slot may be the slot where the PDCCH transmission carrying the DCI format 511 is transmitted by the BS (or received by the UE). For example, in FIG. 5, the PDCCH transmission carrying the DCI format 511 is in slot 0 on carrier 501, and the first reference slot is slot 0 on carrier 501. In some embodiments, this option may not apply to the second cell group, because the DCI format 511 is not transmitted in a carrier in the second cell group. In some other embodiments, this option may not apply to the first cell group when the DCI format is not transmitted on a carrier in the first cell group.

According to some embodiments of the present disclosure, the UE may first generate HARQ-ACK information bits for all the PDSCH transmissions scheduled on carriers within the first cell group, and then concatenate these HARQ-ACK information bits based on an order (e.g., in ascending order) of serving cell indices of the corresponding scheduled carriers to form the HARQ-ACK codebook to be transmitted in the first PUCCH slot.

The total number of HARQ-ACK information bits in the HARQ-ACK codebook for the PDSCH transmissions scheduled by a single DCI format may be equal to a value configured by RRC signaling. Two independent values may be configured by RRC signaling for the two cell groups, respectively. In the case that the number of HARQ-ACK information bits generated for all the scheduled PDSCH transmissions scheduled on carriers within the first cell group is smaller than the value configured for the first cell group, the UE may perform HARQ-ACK padding to the HARQ-ACK information bits, e.g., appending one or more NACK bits in the HARQ-ACK codebook, to align the configured value. In the case that the number of HARQ-ACK information bits generated for all the scheduled PDSCH transmissions scheduled on carriers within the first cell group is larger than the value configured for the first cell group, the UE may perform HARQ-ACK bundling, e.g., performing logic AND operation among the HARQ-ACK information bits, to align the configured value.

At BS side, for each cell group, the BS may determine a reference subcarrier spacing, a reference slot, and a HARQ-ACK feedback timing offset for the UE to determine a PUCCH slot, and transmit the DCI format 511 including an indicator (in the case of embodiment 1) or two indicators (in the case of embodiment 2) indicating the HARQ-ACK feedback timing offset(s) to the UE. The DCI format 511 schedules the PDSCH transmissions 521, 522, 523, and 524. The BS may determine the first PUCCH slot for receiving a first HARQ-ACK codebook for PDSCH transmissions 521 and 522 based on at least one of the reference subcarrier spacing, the reference slot, and the HARQ-ACK feedback timing offset (e.g., based on formula (2)) for the first cell group, and receive the first HARQ-ACK codebook in the determined first PUCCH slot. The BS may also determine the second PUCCH slot for receiving a second HARQ-ACK codebook for PDSCH transmissions 523 and 524 in a similar manner, and receive the second HARQ-ACK codebook in the determined second PUCCH slot.

At UE side, after decoding the DCI format 511 from the BS which schedules the PDSCH transmissions 521, 522, 523, and 524, the UE may first determine the number of cell groups and carriers within each cell group. In the case that there are two cell groups, the UE then may determine the first reference subcarrier spacing (e.g., based on any of Options D1-D18) and the first reference slot (e.g., based on any of Options E1-E3), and further determine the first PUCCH slot for transmitting the first HARQ-ACK codebook for PDSCH transmissions 521 and 522 based on at least one of the first reference subcarrier spacing, the first reference slot, and the first HARQ-ACK feedback timing offset as indicated by the DCI format 511 (e.g., based on formula (2)), and determine the second PUCCH slot for transmitting the second HARQ-ACK codebook for PDSCH transmissions 523 and 524 in a similar manner. After receiving the PDSCH transmissions 521, 522, 523, and 524, the UE may generate the first and second HARQ-ACK codebooks and transmit them in the determined first and second PUCCH slots, respectively.

FIG. 6 illustrates multiple PDSCH transmissions on multiple carriers (in two cell groups) scheduled by a single DCI format and two PUCCHs each carrying a HARQ-ACK feedback for PDSCH transmissions on carriers in one cell group according to some embodiments of the present disclosure, where only cross-carrier scheduling is supported.

As shown in FIG. 6, a DCI format 611 is transmitted in a PDCCH on carrier 601, and schedules PDSCH transmissions 621, 622, 623, and 624 on carriers 602, 603, 604, and 605 respectively. The serving cell indices associated with carriers 601, 602, 603, 604, and 605 may be 1, 2, 3, 4, and 5 respectively. The five carriers have different subcarrier spacings. For example, the subcarrier spacing of carrier 601 is 15 kHz, the subcarrier spacing of carrier 602 is 15 kHz, the subcarrier spacing of carrier 603 is 30 kHz, the subcarrier spacing of carrier 604 is 60 kHz, and the subcarrier spacing of carrier 605 is 120 kHz. Carriers 601-603 are included in cell group 641, and carriers 604 and 605 are included in cell group 642.

The UE may determine a first slot for transmitting a first PUCCH 631 carrying a first HARQ-ACK feedback for the PDSCH transmissions 621 and 622 and a second slot for transmitting a second PUCCH 632 carrying a second HARQ-ACK feedback for the PDSCH transmissions 623 and 624 according to the method described above with respect to FIG. 5. The UE may transmit the first and second HARQ-ACK feedbacks in the determined first and second slots, respectively.

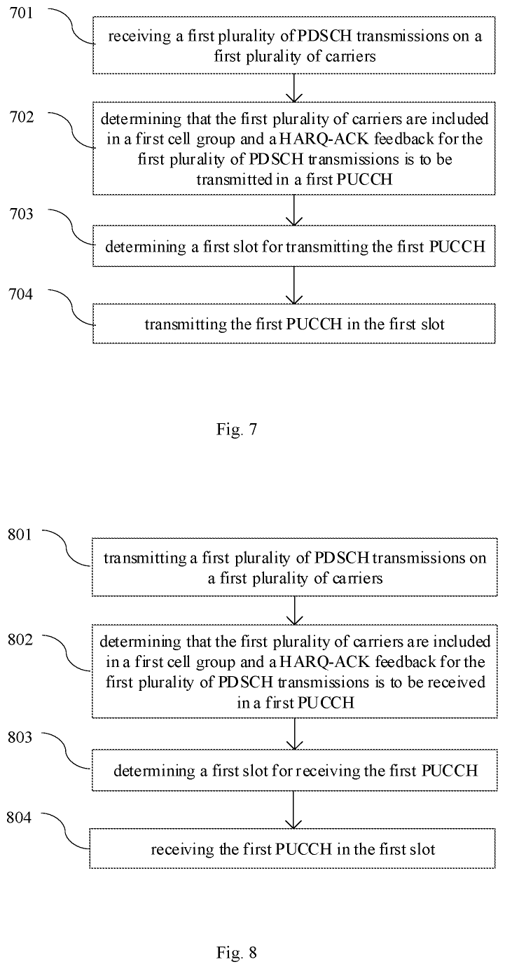

FIG. 7 illustrates a flowchart of an exemplary method for HARQ-ACK feedback according to some embodiments of the present disclosure. Although the method is described with respect to a UE below, it is contemplated that the method may be performed by any other device with similar functions.

In operation 701, the UE may receive a first plurality of PDSCH transmissions on a first plurality of carriers, wherein the first plurality of PDSCH transmissions is scheduled by a DCI format. In operation 702, the UE may determine that the first plurality of carriers are included in a first cell group and a HARQ-ACK feedback for the first plurality of PDSCH transmissions is to be transmitted in a first PUCCH. In operation 703, the UE may determine a first slot for transmitting the first PUCCH, wherein the first slot is determined based on at least one of a first reference subcarrier spacing, a first reference slot, or a first HARQ-ACK feedback timing offset between the first reference slot and the first slot. In operation 704, the UE may transmit the first PUCCH in the first slot.

For example, as shown in FIG. 5, the UE may receive PDSCH transmission 521 on carrier 501 and PDSCH transmission 522 on carrier 502, which are scheduled by the DCI format 511. The UE may determine that carrier 501 and carrier 502 are included in the cell group 541, and the HARQ-ACK feedback for PDSCH transmissions 521 and 522 is to be transmitted in the PUCCH 531. The UE may determine the first slot for transmitting the PUCCH 531, and may transmit the PUCCH 531 in the first slot.

In some embodiments, the UE may further receive a second plurality of PDSCH transmissions on a second plurality of carriers, wherein both the first plurality of PDSCH transmissions and the second plurality of PDSCH transmissions are scheduled by the DCI format. The UE then may determine that the second plurality of carriers are included in a second cell group and a HARQ-ACK feedback for the second plurality of PDSCH transmissions is to be transmitted in a second PUCCH. The UE may further determine a second slot for transmitting the second PUCCH, wherein the second slot is determined based on at least one of a second reference subcarrier spacing, a second reference slot, or a second HARQ-ACK feedback timing offset between the second reference slot and the second slot. The UE then may transmit the second PUCCH in the second slot.

For example, as shown in FIG. 5, the UE may further receive PDSCH transmission 523 on carrier 503 and PDSCH transmission 524 on carrier 504, which are also scheduled by the DCI format 511. The UE may determine that carrier 503 and carrier 504 are included in the cell group 542, and the HARQ-ACK feedback for PDSCH transmissions 523 and 524 is to be transmitted in the PUCCH 532. The UE may determine the second slot for transmitting the PUCCH 532, and may transmit the second PUCCH 532 in the second slot.

In some embodiments, the first cell group and the second cell group are determined based on at least one of the following: the first cell group and the second cell group are within different frequency ranges; one of the first cell group and the second cell group is on a shared spectrum for access and the other cell group is not on a shared spectrum for access; or the first plurality of carriers is configured within the first cell group and the second plurality of carriers is configured within the second cell group by RRC signaling.

In some embodiments, the first HARQ-ACK feedback timing offset and the second HARQ-ACK feedback timing offset are indicated by a single HARQ-ACK feedback timing indicator included in the DCI format (e.g., when embodiment 1 is implemented).

In some embodiments, the first HARQ-ACK feedback timing offset and the second HARQ-ACK feedback timing offset are separately indicated by two HARQ-ACK feedback timing indicators included in the DCI format (e.g., when embodiment 2 is implemented).

In some embodiments, the first reference subcarrier spacing is determined based on at least one of the following:
the first reference subcarrier spacing is configured by an RRC signaling;
the first reference subcarrier spacing is a subcarrier spacing associated with a carrier where the first PUCCH is to be transmitted, e.g., the subcarrier spacing associated with carrier 502 where the PUCCH 531 is to be transmitted in FIG. 5;
the first reference subcarrier spacing is a subcarrier spacing associated with a carrier where the DCI format is received, e.g., the subcarrier spacing associated with carrier 501 where the DCI format 511 is received in FIG. 5;
the first reference subcarrier spacing is a largest subcarrier spacing among all subcarrier spacings of the first plurality of carriers, e.g., the subcarrier spacing associated with carrier 502 in FIG. 5;
the first reference subcarrier spacing is a smallest subcarrier spacing among all subcarrier spacings of the first plurality of carriers, e.g., the subcarrier spacing associated with carrier 501 in FIG. 5;
the first reference subcarrier spacing is a subcarrier spacing associated with a carrier where a last PDSCH transmission of the first plurality of PDSCH transmissions is received, e.g., the subcarrier spacing associated with carrier 502 where PDSCH transmission 522 is received in FIG. 5;
the first reference subcarrier spacing is a subcarrier spacing associated with a carrier where an earliest PDSCH transmission of the first plurality of PDSCH transmissions is received, e.g., the subcarrier spacing associated with carrier 501 where PDSCH transmission 521 is received in FIG. 5;
the first reference subcarrier spacing is a subcarrier spacing associated with a carrier with a smallest serving cell index among all carriers configured for the UE in the first cell group, e.g., the subcarrier spacing associated with carrier 501 with a smallest serving cell index among all carriers configured for the UE in cell group 541 in FIG. 5;
the first reference subcarrier spacing is a subcarrier spacing associated with a carrier with a smallest serving cell index among all carriers scheduled by the DCI format, e.g., the subcarrier spacing associated with carrier 501 with a smallest serving cell index among carriers 501, 502, 503, and 504 scheduled by the DCI format 511 in FIG. 5;
the first reference subcarrier spacing is a subcarrier spacing associated with a carrier with a smallest serving cell index among the first plurality of carriers, e.g., the subcarrier spacing associated with carrier 501 with a smallest serving cell index among carriers 501 and 502 in FIG. 5;
the first reference subcarrier spacing is a subcarrier spacing associated with a carrier with a largest serving cell index among all carriers configured for the UE in the first cell group, e.g., the subcarrier spacing associated with carrier 502 with a largest serving cell index among all carriers configured for the UE in cell group 541 in FIG. 5;
the first reference subcarrier spacing is a subcarrier spacing associated with a carrier with a largest serving cell index among all carriers scheduled by the DCI format, e.g., the subcarrier spacing associated with carrier 504 with a largest serving cell index among carriers 501, 502, 503, and 504 scheduled by the DCI format 511 in FIG. 5;
the first reference subcarrier spacing is a subcarrier spacing associated with a carrier with a largest serving cell index among the first plurality of carriers, e.g., the subcarrier spacing associated with carrier 502 with a largest serving cell index among carriers 501 and 502 in FIG. 5;
the first reference subcarrier spacing is a subcarrier spacing associated with a first scheduled carrier among all carriers scheduled by the DCI format, e.g., the subcarrier spacing associated with carrier 501 which is the first scheduled among carriers 501, 502, 503, and 504 scheduled by the DCI format 511 in FIG. 5;
the first reference subcarrier spacing is a subcarrier spacing associated with a first scheduled carrier among the first plurality of carriers, e.g., the subcarrier spacing associated with carrier 501 which is the first scheduled among carriers 501 and 502 in FIG. 5;
the first reference subcarrier spacing is a subcarrier spacing associated with a last scheduled carrier among all carriers scheduled by the DCI format, e.g., the subcarrier spacing associated with carrier 503 which is the last scheduled among carriers 501, 502, 503, and 504 scheduled by the DCI format 511 in FIG. 5;
the first reference subcarrier spacing is a subcarrier spacing associated with a last scheduled carrier among all the first plurality of carriers, e.g., the subcarrier spacing associated with carrier 502 which is the last scheduled among carriers 501 and 502 in FIG. 5; or
the first reference subcarrier spacing is a subcarrier spacing associated with the first reference slot.

In some embodiments, the first reference slot is determined based on one of the following:
the first reference slot is a slot where a last PDSCH transmission in the first plurality of PDSCH transmissions is received, e.g., slot 1 on carrier 502 where PDSCH transmission 522 is received in FIG. 5;
the first reference slot is a slot where an earliest PDSCH transmission in the first plurality of PDSCH transmissions is received, e.g., slot 0 on carrier 501 where PDSCH transmission 521 is received in FIG. 5; or
the first reference slot is a slot where the DCI format is received, e.g., slot 0 on carrier 501 in FIG. 5.

In some embodiments, HARQ-ACK information bits for the first plurality of PDSCH transmissions are generated per scheduled carrier among the first plurality of carriers and then concatenated based on an order of serving cell indices of the corresponding scheduled carriers.

In some embodiments, a total number of the HARQ-ACK information bits for the first plurality of PDSCH transmissions is configured by RRC signaling.

FIG. 8 illustrates a flowchart of another exemplary method for HARQ-ACK feedback according to some embodiments of the present disclosure. Although the method is described with respect to a BS below, it is contemplated that the method may be performed by any other device with similar functions.

In operation 801, the BS may transmit a first plurality of PDSCH transmissions on a first plurality of carriers, wherein the first plurality of PDSCH transmissions is scheduled by a DCI format; in operation 802, the BS may determine that the first plurality of carriers are included in a first cell group and a HARQ-ACK feedback for the first plurality of PDSCH transmissions is to be received in a first PUCCH. In operation 803, the BS may determine a first slot for receiving the first PUCCH, wherein the first slot is determined based on at least one of a first reference subcarrier spacing, a first reference slot, or a first HARQ-ACK feedback timing offset between the first reference slot and the first slot. In operation 804, the BS may receive the first PUCCH in the first slot. It is contemplated that, in some embodiments of the present disclosure, the method performed by the BS may include additional steps as described above with respect to any of FIGS. 3-6.

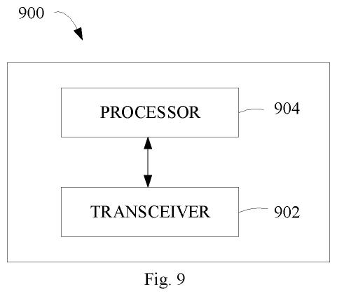

FIG. 9 illustrates a simplified block diagram of an exemplary apparatus for HARQ-ACK feedback according to some embodiments of the present disclosure.

As shown in FIG. 9, the apparatus 900 may include at least one processor 904 and at least one transceiver 902 coupled to the processor 904. The apparatus 900 may be a UE or a BS or any other device with similar functions.

Although in this figure, elements such as the at least one transceiver 902 and processor 904 are described in the singular, the plural is contemplated unless a limitation to the singular is explicitly stated. In some embodiments of the present disclosure, the transceiver 902 may be divided into two devices, such as a receiving circuitry and a transmitting circuitry. In some embodiments of the present disclosure, the apparatus 900 may further include an input device, a memory, and/or other components.

In some embodiments of the present disclosure, the apparatus 900 may be a UE. The transceiver 902 and the processor 904 may interact with each other so as to perform the operations of the UE described in any of FIGS. 1-8. In some embodiments of the present disclosure, the apparatus 900 may be a BS. The transceiver 902 and the processor 904 may interact with each other so as to perform the operations of the BS described in any of FIGS. 1-8.

In some embodiments of the present disclosure, the apparatus 900 may further include at least one non-transitory computer-readable medium.

For example, in some embodiments of the present disclosure, the non-transitory computer-readable medium may have stored thereon computer-executable instructions to cause the processor 904 to implement the method with respect to the UE as described above. For example, the computer-executable instructions, when executed, cause the processor 904 interacting with transceiver 902 to perform the operations of the UE described in any of FIGS. 1-8.

In some embodiments of the present disclosure, the non-transitory computer-readable medium may have stored thereon computer-executable instructions to cause the processor 904 to implement the method with respect to the BS as described above. For example, the computer-executable instructions, when executed, cause the processor 904 interacting with transceiver 902 to perform the operations of the BS described in any of FIGS. 1-8.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
receive a first plurality of physical downlink shared channel (PDSCH) transmissions on a first plurality of carriers, wherein the first plurality of PDSCH transmissions is scheduled by a downlink control information (DCI) format;
determine that the first plurality of carriers are included in a first cell group and a hybrid automatic repeat request-acknowledgement (HARQ-ACK) feedback for the first plurality of PDSCH transmissions is to be transmitted in a first physical uplink control channel (PUCCH);
determine a first slot for transmitting the first PUCCH, wherein the first slot is determined based on at least one of a first reference subcarrier spacing, a first reference slot, or a first HARQ-ACK feedback timing offset between the first reference slot and the first slot; and
transmit the first PUCCH in the first slot.

2. The UE of claim 1, wherein the at least one processor is further configured to cause the UE to:
receive a second plurality of PDSCH transmissions on a second plurality of carriers, wherein both the first plurality of PDSCH transmissions and the second plurality of PDSCH transmissions are scheduled by the DCI format;
determine that the second plurality of carriers are included in a second cell group and a HARQ-ACK feedback for the second plurality of PDSCH transmissions is to be transmitted in a second PUCCH;
determine a second slot for transmitting the second PUCCH, wherein the second slot is determined based on at least one of a second reference subcarrier spacing, a second reference slot, or a second HARQ-ACK feedback timing offset between the second reference slot and the second slot; and
transmit the second PUCCH in the second slot.

3. The UE of claim 2, wherein the first cell group and the second cell group are determined based on at least one of:
the first cell group and the second cell group are within different frequency ranges;
one of the first cell group or the second cell group is on a shared spectrum for access and the other cell group is not on the shared spectrum for access; or
the first plurality of carriers is configured within the first cell group and the second plurality of carriers is configured within the second cell group by radio resource control (RRC) signaling.

4. The UE of claim 2, wherein the first HARQ-ACK feedback timing offset and the second HARQ-ACK feedback timing offset are indicated by a single HARQ-ACK feedback timing indicator included in the DCI format.

5. The UE of claim 2, wherein the first HARQ-ACK feedback timing offset and the second HARQ-ACK feedback timing offset are separately indicated by two HARQ-ACK feedback timing indicators included in the DCI format.

6. The UE of claim 1, wherein the first reference subcarrier spacing is determined based on the first reference subcarrier spacing is at least one of:
configured by an RRC signaling;
a subcarrier spacing associated with a carrier where the first PUCCH is to be transmitted;
a subcarrier spacing associated with a carrier where the DCI format is received;
a largest subcarrier spacing among all subcarrier spacings of the first plurality of carriers;
a smallest subcarrier spacing among all subcarrier spacings of the first plurality of carriers;
a subcarrier spacing associated with a carrier where a last PDSCH transmission of the first plurality of PDSCH transmissions is received;
a subcarrier spacing associated with a carrier where an earliest PDSCH transmission of the first plurality of PDSCH transmissions is received;
a subcarrier spacing associated with a carrier with a smallest serving cell index among all carriers configured for the UE in the first cell group;
a subcarrier spacing associated with a carrier with a smallest serving cell index among all carriers scheduled by the DCI format;
a subcarrier spacing associated with a carrier with a smallest serving cell index among the first plurality of carriers;
a subcarrier spacing associated with a carrier with a largest serving cell index among all carriers configured for the UE in the first cell group;
a subcarrier spacing associated with a carrier with a largest serving cell index among all carriers scheduled by the DCI format;
a subcarrier spacing associated with a carrier with a largest serving cell index among the first plurality of carriers;
a subcarrier spacing associated with a first scheduled carrier among all carriers scheduled by the DCI format;
a subcarrier spacing associated with a first scheduled carrier among the first plurality of carriers;
a subcarrier spacing associated with a last scheduled carrier among all carriers scheduled by the DCI format;
a subcarrier spacing associated with a last scheduled carrier among all the first plurality of carriers; or
a subcarrier spacing associated with the first reference slot.

7. The UE of claim 1, wherein the first reference slot is determined based on the first reference slot is one of:
a slot where a last PDSCH transmission in the first plurality of PDSCH transmissions is received;
a slot where an earliest PDSCH transmission in the first plurality of PDSCH transmissions is received; or
a slot where the DCI format is received.

8. The UE of claim 1, wherein HARQ-ACK information bits for the first plurality of PDSCH transmissions are generated per scheduled carrier among the first plurality of carriers and then concatenated based on an order of serving cell indices of corresponding scheduled carriers.

9. The UE of claim 8, wherein a total number of the HARQ-ACK information bits for the first plurality of PDSCH transmissions is configured by radio resource control (RRC signaling.

10. A base station (BS) for wireless communication, comprising:
at least one memory; and
at least one processor coupled with the at least one memory and configured to cause the BS to:
transmit a first plurality of physical downlink shared channel (PDSCH) transmissions on a first plurality of carriers, wherein the first plurality of PDSCH transmissions is scheduled by a downlink control information (DCI) format;
determine that the first plurality of carriers are included in a first cell group and a hybrid automatic repeat request-acknowledgement (HARQ-ACK) feedback for the first plurality of PDSCH transmissions is to be received in a first physical uplink control channel (PUCCH);
determine a first slot for receiving the first PUCCH, wherein the first slot is determined based on at least one of a first reference subcarrier spacing, a first reference slot, or a first HARQ-ACK feedback timing offset between the first reference slot and the first slot; and
receive the first PUCCH in the first slot.

11. The BS of claim 10, wherein the at least one processor is further configured to cause the BS to:
transmit a second plurality of PDSCH transmissions on a second plurality of carriers, wherein both the first plurality of PDSCH transmissions and the second plurality of PDSCH transmissions are scheduled by the DCI format;
determine that the second plurality of carriers are included in a second cell group and a HARQ-ACK feedback for the second plurality of PDSCH transmissions is to be received in a second PUCCH;
determine a second slot for receiving the second PUCCH, wherein the second slot is determined based on at least one of a second reference subcarrier spacing, a second reference slot, or a second HARQ-ACK feedback timing offset between the second reference slot and the second slot; and
receive the second PUCCH in the second slot.

12. The BS of claim 11, wherein the first cell group and the second cell group are determined based on at least one of:
the first cell group and the second cell group are within different frequency ranges;
one of the first cell group and the second cell group is on a shared spectrum for access and the other cell group is not on a shared spectrum for access; or
the first plurality of carriers is configured within the first cell group and the second plurality of carriers is configured within the second cell group by radio resource control (RRC) signaling.

13. (canceled)

14. The BS of claim 10, wherein the first reference slot is determined based on the first reference slot is one of:
a slot where a last PDSCH transmission in the first plurality of PDSCH transmissions is transmitted;
a slot where an earliest PDSCH transmission in the first plurality of PDSCH transmissions is transmitted; or
a slot where the DCI format is transmitted.

15. A method performed by a user equipment (UE), the method comprising:
receiving a first plurality of physical downlink shared channel (PDSCH) transmissions on a first plurality of carriers, wherein the first plurality of PDSCH transmissions is scheduled by a downlink control information (DCI) format;
determining that the first plurality of carriers are included in a first cell group and a hybrid automatic repeat request-acknowledgement (HARQ-ACK) feedback for the first plurality of PDSCH transmissions is to be transmitted in a first physical uplink control channel (PUCCH);
determining a first slot for transmitting the first PUCCH, wherein the first slot is determined based on at least one of a first reference subcarrier spacing, a first reference slot, or a first HARQ-ACK feedback timing offset between the first reference slot and the first slot; and
transmitting the first PUCCH in the first slot.

16. A processor for wireless communication, comprising:
at least one controller coupled with at least one memory and configured to cause the processor to:
receive a first plurality of physical downlink shared channel (PDSCH) transmissions on a first plurality of carriers, wherein the first plurality of PDSCH transmissions is scheduled by a downlink control information (DCI) format;
determine that the first plurality of carriers are included in a first cell group and a hybrid automatic repeat request-acknowledgement (HARQ-ACK) feedback for the first plurality of PDSCH transmissions is to be transmitted in a first physical uplink control channel (PUCCH);
determine a first slot for transmitting the first PUCCH, wherein the first slot is determined based on at least one of a first reference subcarrier spacing, a first reference slot, or a first HARQ-ACK feedback timing offset between the first reference slot and the first slot; and
transmit the first PUCCH in the first slot.

17. The processor of claim 16, wherein the at least one controller is configured to cause the processor to:
receive a second plurality of PDSCH transmissions on a second plurality of carriers, wherein both the first plurality of PDSCH transmissions and the second plurality of PDSCH transmissions are scheduled by the DCI format;
determine that the second plurality of carriers are included in a second cell group and a HARQ-ACK feedback for the second plurality of PDSCH transmissions is to be transmitted in a second PUCCH;
determine a second slot for transmitting the second PUCCH, wherein the second slot is determined based on at least one of a second reference subcarrier spacing, a second reference slot, or a second HARQ-ACK feedback timing offset between the second reference slot and the second slot; and
transmit the second PUCCH in the second slot.

18. The processor of claim 17, wherein the first cell group and the second cell group are determined based on at least one of:
the first cell group and the second cell group are within different frequency ranges;
one of the first cell group or the second cell group is on a shared spectrum for access and the other cell group is not on the shared spectrum for access; or
the first plurality of carriers is configured within the first cell group and the second plurality of carriers is configured within the second cell group by radio resource control (RRC) signaling.

19. The processor of claim 17, wherein the first HARQ-ACK feedback timing offset and the second HARQ-ACK feedback timing offset are indicated by a single HARQ-ACK feedback timing indicator included in the DCI format.

20. The processor of claim 17, wherein the first HARQ-ACK feedback timing offset and the second HARQ-ACK feedback timing offset are separately indicated by two HARQ-ACK feedback timing indicators included in the DCI format.

21. The processor of claim 16, wherein the first reference slot is determined based on the first reference slot is one of a slot where a last PDSCH transmission in the first plurality of PDSCH transmissions is received, a slot where an earliest PDSCH transmission in the first plurality of PDSCH transmissions is received, or a slot where the DCI format is received.
